(19) United States
(12) Patent Application Publication
(10) Pub. No.: US 2025/0267070 A1
(43) Pub. Date: Aug. 21, 2025

(54) NWDAF-BASED SIGNALING STORM CONTROL METHOD AND DEVICE FOR PERFORMING THE SAME

(71) Applicant: ELECTRONICS AND TELECOMMUNICATIONS RESEARCH INSTITUTE, Daejeon (KR)

(72) Inventors: Jonggwan AN, Daejeon (KR); Jihoon SUNG, Daejeon (KR); Myung Ki SHIN, Seoul (KR)

(73) Assignee: ELECTRONICS AND TELECOMMUNICATIONS RESEARCH INSTITUTE, Daejeon (KR)

(21) Appl. No.: 18/968,664

(22) Filed: Dec. 4, 2024

(30) Foreign Application Priority Data
Feb. 16, 2024 (KR) 10-2024-0022869
Apr. 5, 2024 (KR) 10-2024-0046579
May 8, 2024 (KR) 10-2024-0060379
May 17, 2024 (KR) 10-2024-0064516
Aug. 9, 2024 (KR) 10-2024-0106927
Aug. 30, 2024 (KR) 10-2024-0118068
Oct. 22, 2024 (KR) 10-2024-0145105
Nov. 13, 2024 (KR) 10-2024-0160974

(51) Int. Cl. H04L 41/14; H04L 47/11; H04L 47/12; H04L 47/19; H04L 47/28; H04W 28/02

(52) U.S. Cl. CPC H04L 41/14; H04L 47/11; H04L 47/12; H04L 47/19; H04L 47/28; H04W 28/0215

(57) ABSTRACT

Disclosed are a network data analytics function (NWDAF)-based signaling storm control method and a device for performing the same. A method of controlling a signaling storm includes receiving a request for analytics of a signaling storm from a consumer network function (NF), collecting data for the analytics of the signaling storm from a fifth-generation core (5GC) NF, generating analytics information about the signaling storm based on the collected data, and transmitting the analytics information to the consumer NF, wherein the analytics information may include one of statistics and predictions regarding control of the signaling storm to mitigate or prevent a network abnormal behavior.

### CROSS-REFERENCE TO RELATED APPLICATIONS

This application claims the benefit of Korean Patent Application No. 10-2024-0022869 filed on Feb. 16, 2024, Korean Patent Application No. 10-2024-0046579 filed on Apr. 5, 2024, Korean Patent Application No. 10-2024-0060379 filed on May 8, 2024, Korean Patent Application No. 10-2024-0064516 filed on May 17, 2024, Korean Patent Application No. 10-2024-0106927 filed on Aug. 9, 2024, Korean Patent Application No. 10-2024-0118068 filed on Aug. 30, 2024, Korean Patent Application No. 10-2024-0145105 filed on Oct. 22, 2024, and Korean Patent Application No. 10-2024-0160974 filed on Nov. 13, 2024, in the Korean Intellectual Property Office, the entire disclosures of which are incorporated herein by reference for all purposes.

### BACKGROUND

### 1. Field of the Invention

One or more embodiments relate to a network data analytics function (NWDAF)-based signaling storm control method and a device for performing the same.

### 2. Description of the Related Art

A fifth-generation (5G) mobile communication system defined an NWDAF, which is a network function that provides a function to analyze and provide data collected from 5G networks.

For automation and optimization of the 5G mobile communication system, NWDAF collects raw data of each network function and application function, converts the raw data into big data, and processes the big data to provide network analytics information.

Sixth generation (6G) aims to encompass Internet of Things (IoT) devices in a massive mobile communication system. The 5G/6G system needs to manage IoT devices that are much more than the number of existing terminals and thus, requires congestion control management technology.

The above description is information the inventor(s) acquired during the course of conceiving the present disclosure, or already possessed at the time, and is not necessarily art publicly known before the present application was filed.

### SUMMARY

To encompass massive Internet of Things (IoT) devices in a mobile communication system, an improved dynamic congestion control to analyze and predict communication patterns of terminals is required.

An embodiment may provide congestion control technology for considering a communication pattern and guaranteeing transmission for massive IoT devices in a mobile communication system.

An embodiment may provide technology for controlling a signaling storm based on a network data analytics function (NWDAF).

However, the technical goals are not limited to those described above, and other technical goals may be present.

According to an aspect, there is provided a method of controlling a signaling storm, the method including receiving a request for analytics of a signaling storm from a consumer network function (NF), collecting data for the analytics of the signaling storm from a fifth-generation core (5GC) NF, generating analytics information about the signaling storm based on the collected data, and transmitting the analytics information to the consumer NF, wherein the analytics information may include one of statistics and predictions regarding control of the signaling storm to mitigate or prevent a network abnormal behavior.

The analytics information may be regarding an expected normal level of the signaling storm and deviations indicating the signaling storm.

The generating may include identifying whether the signaling storm is due to signaling from a predetermined NF or signaling from a user equipment (UE) based on analytics identification (ID) of the signaling storm included in the request.

The data may include UE-related context data, and the UE-related context data may include information regarding a time duration from receiving a request from a UE to response to the UE, a number of successful responses of the UE, a number of failed responses of the UE, a frequent mobility registration update, a UE context in an NF, state transition information, and timer information.

The timer information may be timer information set for the UE, and include a timer type and a duration.

The data may include application function (AF) data indicating application activation time information, and the AF data may include information regarding an application ID, user activation time information, a number of UEs, an active time, an inactive time, and a UE type ID.

An action for the signaling storm may be performed based on the analytics information.

If the consumer NF is an access and mobility management function (AMF), the action may be setting a mobility management non-access stratum (MM NAS)-related timer.

If the consumer NF is a session management function (SMF), the action may be setting a session management non-access stratum (SM NAS)-related timer.

According to an aspect, there is provided a server device for controlling a signaling storm, the server device including a processor, and a memory electrically connected to the processor and configured to store instructions executable by the processor, wherein the instructions, when executed by the processor, may cause the server device to perform a plurality of operations, the plurality of operations including receiving a request for analytics of a signaling storm from a consumer NF, collecting data for the analytics of the signaling storm from a 5GC NF, generating analytics information about the signaling storm based on the collected data, and transmitting the analytics information to the consumer NF, wherein the analytics information may include one of statistics and predictions regarding control of the signaling storm to mitigate or prevent a network abnormal behavior.

The analytics information may be regarding an expected normal level of the signaling storm and deviations indicating the signaling storm.

The generating may include identifying whether the signaling storm is due to signaling from a predetermined NF or signaling from a UE based on analytics ID of the signaling storm included in the request.

The data may include UE-related context data, and the UE-related context data may include information regarding a time duration from receiving a request from a UE to response to the UE, a number of successful responses of the UE, a number of failed responses of the UE, a frequent mobility registration update, a UE context in an NF, state transition information, and timer information.

The timer information may be timer information set for the UE, and include a timer type and a duration.

The data may include AF data indicating application activation time information, and the AF data may include information regarding an application ID, user activation time information, a number of UEs, an active time, an inactive time, and a UE type ID.

An action for the signaling storm may be performed based on the analytics information.

If the consumer NF is an AMF, the action may be setting an MM NAS-related timer.

If the consumer NF is an SMF, the action may be setting a SM NAS-related timer.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a network system according to an embodiment;

FIG. 2 is a diagram illustrating network data analytics according to an embodiment;

FIG. 3 is a diagram illustrating a signaling storm analytics process according to an embodiment;

FIG. 4 is a flowchart illustrating a method of controlling a network signaling storm according to an embodiment; and

FIG. 5 is a schematic block diagram of a device for performing an NWDAF according to an embodiment.

### DETAILED DESCRIPTION

The following structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

When it is mentioned that one component is “connected” or “accessed” to another component, it may be understood that the one component is directly connected or accessed to in another component or that still other component is interposed between the two components.

The singular forms “a”, “an”, and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, the term “unit” is not limited to software or hardware. A “unit” may be configured to be in an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like components, and any repeated description related thereto will be omitted.

Terms used herein to identify a connection node, to indicate network entities, to indicate messages, to indicate an interface among network entities, to indicate various pieces of identification information are examples for ease of description. Thus, terms are not limited to terms described later in this disclosure and other terms referring to a subject having the equivalent technical meaning may be used.

Herein, for ease of description, of the currently existing communication standards, terms and names defined by long-term evolution (LTE) and new radio (NR) standards, which are the latest standards defined by the third-generation partnership project (3GPP) association, are used. However, embodiments described hereinafter are not limited to the terms and names and a system in compliance with other standards may be applicable in the same manner.

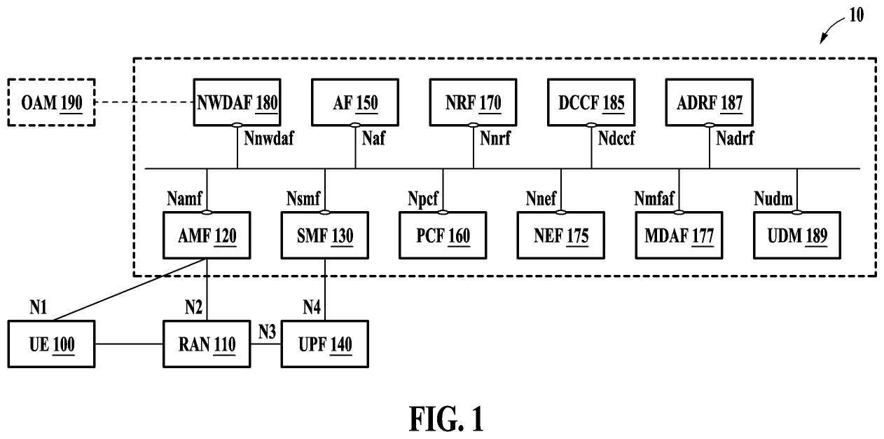

FIG. 1 illustrates a network system according to an embodiment.

Referring to FIG. 1, according to an embodiment, a network system 10 (e.g., a fifth-generation (5G) network system, a sixth-generation (6G) network system, or a 5G/6G network system) may include a plurality of entities 100 to 190. A user equipment (UE) (or a user terminal) 100 may access a 5D core network through a radio access network (RAN) 110. The RAN 110 may be a base station that provides a wireless communication function to the UE 100. An operation, administration, and maintenance (OAM) 190 may be a system for managing terminals and networks.

The unit performed by each function provided by the network system 10 may be defined as a network function (NF). The NF may include an access and mobility management function (AMF) 120, a session management function (SMF) 130, a user plane function (UPF) 140, an application function (AF) 150, a policy control function (PCF) 160, a network repository function (NRF) 170, a network exposure function (NEF) 175, a management data analytics function (MDAF) 177, a network data analytics function (NWDAF) 180, a data collection coordination function (DCCF) 185, an analytics data repository function (ADRF) 187, and a unified data management (UDM) 189. The AMF 120 may manage network access and mobility of a terminal, the SMF 130 may perform a session-related function, the UPF 140 may manage transfer of user data, and the AF 150 may perform a role to communication with a fifth-generation core (5GC) to provide an application service. The PCF 160 may manage a policy, and the NRF 170 may manage a function to store state information of NFs and process a request for finding an NF that other NFs can access.

The NWDAF 180 may analyze data collected from a network (e.g., a 5G network) and provide analytics results to support network automation. The NWDAF 180 may collect/store/analyze information from a network. The NWDAF 180 may collect information from the OAM 190, an NF forming the network (e.g., the AMF 120, the SMF 130, the UPF 140, the PCF 160, the NRF 170, the NEF 175, the MDAF 177, the DCCF 185, the ADRF 187, and/or the UDM 189), a UE, or the AF 150. The NWDAF 180 may provide the analytics results to an unspecified NF (e.g., the AMF 120, the SMF 130, the UPF 140, the PCF 160, the NRF 170, the NEF 175, the MDAF 177, the DCCF 185, the ADRF 187, and/or the UDM 189), the OAM 190, the UE, or the AF 150. The analytics results may be used independently by each NF (e.g., the AMF 120, the SMF 130, the UPF 140, the PCF 160, the NRF 170, the NEF 175, the MDAF 177, the DCCF 185, the ADRF 187, and/or the UDM 189), the OAM 190, the UE, or the AF 150.

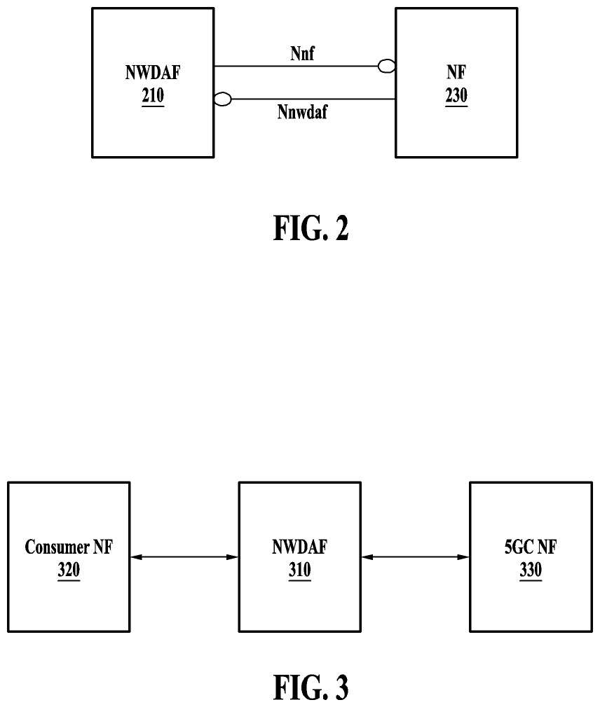

FIG. 2 is a diagram illustrating network data analytics according to an embodiment.

An NWDAF 210 (e.g., the NWDAF 180 of FIG. 1) may provide NWDAF services to an NF 230. The NWDAF services may include services such as analytics information subscription (Nnwdaf_AnalyticsSubscription), analytics information request (Nnwdaf_AnalyticsInfo), data management (Nnwdaf_DataManagement), machine learning (ML) model provisioning (Nnwdaf_MLModelProvision), ML model information request (Nnwdaf_MLModelInfo), ML model monitor (Nnwdaf_MLModelMonitor), ML model training (Nnwdaf_MLModelTraining), ML model training information request (Nnwdaf_MLModelTrainingInfo), roaming user analytics (Nnwdaf_RoamingAnalytics), and roaming data management (Nnwdaf_RoamingData). The NWDAF services provided by the NWDAF 210 may be as in Table 1.

TABLE 1

| | Service | Operation | |
|---|---|---|---|
| Service Name | Operations | Semantics | Example Consumer(s) |
| Nnwdaf_AnalyticsSubscription | Subscribe | Subscribe/Notify | PCF, NSSF, AMF, SMF, |
| | | | NEF, AF, OAM, CEF, |
| | | | NWDAF, DCCF |
| | Unsubscribe | | PCF, NSSF, AMF, SMF, |
| | | | NEF, AF, OAM, CEF, |
| | | | NWDAF, DCCF |
| | Notify | | PCF, NSSF, AMF, SMF, |
| | | | NEF, AF, OAM, CEF, |
| | | | NWDAF, DCCF, MFAF |
| | Transfer | Request/Response | NWDAF |
| Nnwdaf_AnalyticsInfo | Request | Request/Response | PCF, NSSF, AMF, SMF, |
| | | | NEF, AF, OAM, CEF, |
| | | | NWDAF, DCCF |
| | ContextTransfer | Request/Response | NWDAF |
| Nnwdaf_DataManagement | Subscribe | Subscribe/Notify | NWDAF, DCCF |
| | Notify | | NWDAF, DCCF, MFAF, |
| | | | ADRF |
| | Fetch | Request/Response | NWDAF, DCCF, MFAF, |
| | | | ADRF |
| Nnwdaf_MLModelProvision | Subscribe | Subscribe/Notify | NWDAF |
| | Unsubscribe | | NWDAF |
| | Notify | | NWDAF |
| Nnwdaf_MLModelInfo | Request | Request/Response | NWDAF |
| Nnwdaf_MLModelMonitor | Subscribe | Subscribe/Notify | NWDAF |
| | Unsubscribe | | NWDAF |
| | Notify | | NWDAF |
| | Register | Request/Response | NWDAF |
| | Request | | NWDAF |
| Nnwdaf_MLModelTraining | Subscribe | Subscribe/Notify | NWDAF |
| | Unsubscribe | | NWDAF |
| | Notify | | NWDAF |
| Nnwdaf_MLModelTrainingInfo | Request | Request/Response | NWDAF |
| Nnwdaf_RoamingAnalytics | Subscribe | Subscribe/Notify | H-NWDAF, V-NWDAF |
| | Unsubscribe | | H-NWDAF, V-NWDAF |
| | Notify | | H-NWDAF, V-NWDAF |
| | Request | Request/Response | H-NWDAF, V-NWDAF |
| Nnwdaf_RoamingData | Subscribe | Subscribe/Notify | H-NWDAF, V-NWDAF |
| | Unsubscribe | | H-NWDAF, V-NWDAF |
| | Notify | | H-NWDAF, V-NWDAF |

NOTE 1:
How OAM consumes Nnwdaf services and which Analytics information is relevant is defined in TS 28.550 [7] Annex H and out of the scope of this TS.
NOTE 2:
How CEF consumes Nnwdaf services and which Analytics information is relevant is defined in TS 28.201 [21] and out of the scope of this TS.)
NOTE 3:
The Nnwdaf_MLModelProvision service and the Nnwdaf_MLModelInfo service are provided by an NWDAF containing MTLF and consumed by an NWDAF containing AnLF.

The NWDAF 210 may perform analytics in response to a request from the NF 230, and provide analytics information (e.g., analytics results) to the NF 230. The NWDAF 210 may provide the analytics information according to the services described in Table 1, as in Table 2.

TABLE 2

| Analytics Information | Request Description | Response Description |
|---|---|---|
| Slice Load level | Analytics ID: load level | Load level provided as number of UE |
| information | information | registrations and number of PDU sessions |
| | | for a Network Slice and Network Slice |
| | | instances as well as resource utilization for |
| | | Network Slice instances. |
| Observed Service | Analytics ID: Service | Observed Service experience statistics or |
| experience information | Experience | predictions may be provided for a Network |
| | | Slice or an Application. They may be |
| | | derived from an individual UE, a group of |
| | | UEs or any UE. For slice service |
| | | experience, they may be derived from an |
| | | application, a set of Applications or all |
| | | Applications on the Network Slice. |
| NF Load information | Analytics ID: NF load | Load statistics or predictions information |
| | information | for specific NF(s). |
| Network Performance | Analytics ID: Network | Statistics or predictions on the load in an |
| information | Performance | Area of Interest; in addition, statistics or |
| | | predictions on the number of UEs that are |
| | | located in that Area of Interest. |
| UE mobility | Analytics ID: UE Mobility | Statistics or predictions on UE mobility. |
| information | | When visited AOI(s) is included in the |
| | | Analytics Filter information, only statistics |
| | | on UE mobility can be provided. |
| UE Communication | Analytics ID: UE | Statistics or predictions on UE |
| information | Communication | communication. |
| Expected UE behavioral | Analytics ID: UE Mobility | Analytics on UE Mobility and/or UE |
| parameters | and/or UE Communication | Communication. |
| UE Abnormal behavior | Analytics ID: Abnormal | List of observed or expected exceptions, |
| information | behavior | with Exception ID, Exception Level and |
| | | other information, depending on the |
| | | observed or expected exceptions. |
| E2E data volume | Analytics ID: E2E data | Analytics on E2E data volume transfer |
| transfer time | volume transfer time | time. |
| User Data Congestion | Analytics ID: User Data | Statistics or predictions on the user data |
| information | Congestion | congestion for transfer over the user plane, |
| | | for transfer over the control plane, or for |
| | | both. |
| QoS Sustainability | Analytics ID: QoS | For statistics, the information on the |
| | Sustainability | location and the time for the QoS change |
| | | and the threshold(s) that were crossed; or, |
| | | for predictions, the information on the |
| | | location and the time when a potential QoS |
| | | change may occur and what threshold(s) |
| | | may be crossed. |
| Session Management | Analytics ID: Session | Statistics on session management |
| Congestion Control | Management Congestion | congestion control experience for specific |
| Experience | Control Experience | DNN and/or S-NSSAI. |
| Redundant | Analytics ID: Redundant | Statistics or predictions aimed at |
| Transmission | Transmission Experience | supporting redundant transmission |
| Experience | | decisions for URLLC services. |
| WLAN performance | Analytics ID: WLAN | Statistics or predictions on WLAN |
| | performance | performance of UE. |
| Dispersion | Analytics ID: UE | Statistics or predictions that identify the |
| | Dispersion | location (i.e. areas of interest) or network |
| | | slice(s) where a UE, or a group of UEs |
| | | disperse their data volume, or disperse |
| | | mobility or session management |
| | | transactions or both. |
| DN Performance | Analytics ID: DN | Statistics or predictions on user plane |
| | Performance | performance for a specific Edge |
| | | Computing application. |
| PFD Determination | Analytics ID: PFD | Statistics on PFD information for a known |
| | Determination | application identifier(s). |
| Movement Behavior | Analytics ID: Movement | Statistics or predictions on movement |
| | Behavior | behavior for an applicable area |
| Signaling Storm | Analytics ID: Signaling | Statistics or predictions on controlling |
| | storm | signaling storm for network abnormal |
| | | behavior mitigation or prevention. |

For example, the NWDAF 210 may analyze “signaling storm” in response to a request from the NF 230 (e.g., analytics regarding Analytics ID=“signaling storm”), and provide the NF 230 with statistics or predictions regarding control of the signaling storm to mitigate or prevent a network abnormal behavior as analytics information.

Hereinafter, among the services of Table 1, the analytics information subscription service (Nnwdaf_AnalyticsSubscription service) and the analytics information request service (Nnwdaf_AnalyticsInfo service) are described in detail.

The NWDAF 210 (e.g., the NWDAF 180 of FIG. 1) may provide the analytics information subscription service (Nnwdaf_AnalyticsSubscription service) to the NF 230. The analytics information subscription service may enable subscription and unsubscription of network data analytics information (or network data analytics results) generated by the NWDAF 210. The analytics information subscription service may receive network analytics information (or network analytics results) periodically according to the need of a network function of the NF 230 subscribing to the service or receive analytics information (or analytics results) if a predetermined condition is satisfied. The analytics information subscription service may be provided through three operations of subscription, unsubscription, and notification.

The subscription operation (Nnwdaf_AnlayticsSubscription_Subscribe operation) may include a required input and/or an optional input. The required input may include single network slice selection assistance information (S-NSSAI), an event identifier or analytics ID (or analytics information ID), a notification target address, and event reporting information. The optional input may include information additionally required to process the analytics information. For example, the optional input may include an event filter or an analytics filter (or an analytics information filter). Of course, the embodiments are not limited to the above examples.

In the unsubscription operation (Nnwdaf_AnlayticsSubscription_Unsubscribe operation), the NF 230 may transmit the subscription identifier information to the NWDAF 180, and the NWDAF 210 may transmit, as output, a message informing that unsubscription has been confirmed, to the NF 230 that requested unsubscription.

In the notification operation (Nnwdaf_AnlayticsSubscription_Notify operation), the NWDAF 210 may notify the NF 230 successfully subscribing to the analytics information subscription service of designated network data analytics information (or network data analytics results) periodically or when a predetermined condition is satisfied. The notification operation may include an event identifier or analytics ID (or analytics information ID), and a notification target address.

The NWDAF 210 may provide the analytics information request service (Nnwdaf_AnalyticsInfo service) to the NF 230. The analytics information request service, unlike the analytics information subscription service, may be a service for the NF 230 to request analytics regarding predetermined information and receive result values immediately when the request is completed. The operation of the analytics information request service may include a request and a response. The NF 230 requesting analytics information may transmit an analytics information request message (e.g., Nnwdaf_AnalyticsInfo_Request service operation) to the NWDAF 180.

The NWDAF 210 may transmit the analytics information to each NF 230 requesting the analytics information. The analytics information may be used to optimize the performance of an operation (or a network function) performed by each NF 230 (e.g., congestion control, Quality of Service (QOS) management, traffic control, mobility management, load dispersion, or terminal power control).

The NF 230 (e.g., the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1) may become a consumer NF requesting analytics results from the NWDAF 210. Each NF 230 may become a service consumer NF of the network data analytics service. The NWDAF 210 may collect data from each NF 230 and analyze the data to generate the analytics information requested by the consumer NF. The NWDAF 210 may transmit the analytics information to the consumer NF transmitting the analytics request. Accordingly, the NWDAF 210 may become a provider NF of the analytics results requested by the consumer NF. The NWDAF 210 may become a service provider NF of the service that provides the analytics information requested by the service consumer NF.

The NWDAF 210 may include one or more of an analytics logical function (AnLF) and a model training logical function (MTLF). The NWDAF 210 may include either the MTLF or the AnLF or may support both.

An NWDAF (e.g., the NWDAF 210) including the AnLF may perform inference and derive analytics information (e.g., derive statistics and/or predictions according to an analytics consumer request). The NWDAF including the AnLF may expose an analytics service for network data (e.g., Nnwdaf_AnalyticsSubscription or Nnwdaf_AnalyticsInfo).

An NWDAF (e.g., the NWDAF 210) including the MTLF may train an ML model, and expose a new training service (e.g., provide the initial version that is not trained or a trained model).

FIG. 3 is a diagram illustrating a signaling storm analytics process according to an embodiment.

An NWDAF 310 (e.g., the NWDAF 180 of FIG. 1 or the NWDAF 210 of FIG. 2) may support analytics for mitigation and prevention of a network abnormal behavior (e.g., a signaling storm). The NWDAF 310 may support signaling storm analytics. In signaling storm analytics, the NWDAF 310 may provide analytics information (e.g., statistics and/or predictions) regarding an expected normal level of signaling and deviations (e.g., significant deviations) indicating a signaling storm. The NWDAF 310 may identify whether the signaling storm is due to signaling from an NF or signaling (e.g., massive signaling) from a UE based on requested analytics ID.

A consumer NF 320 (e.g., the NF 230 of FIG. 2) may transmit a request for signaling storm analytics. The consumer NF 320 may include one or more of the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1.

The consumer NF 320 may trigger the signaling storm analytics based on a trigger condition. That is, the consumer NF 320 may transmit a request for signaling storm analytics to the NWDAF 310. For example, the consumer NF 320 may subscribe to NF load analytics from the NWDAF 310, and trigger the signaling storm analytics based on the output (or analytics information) of the NF load analytics (e.g., CPU usage of 80% or more). In addition, the consumer NF 320 may subscribe to “abnormal behavior” analytics from the NWDAF 310, and trigger the signaling storm analytics based on output of the abnormal behavior analytics (e.g., suspicion of DDoS attack). Further, the consumer NF 320 may subscribe to “dispersion (or dispersion analytics)” analytics from the NWDAF 310, and trigger the signaling storm analytics according to the results of the dispersion analytics (e.g., when the transaction dispersion exceeds an expected transaction dispersion configurable threshold).

The NWDAF 310 may receive a request for signaling storm analytics from the consumer NF 320 (e.g., the NF 230 of FIG. 2). The request for signaling storm analytics may be analytics information subscription (Nnwdaf_AnalyticsSubscription) or analytics information request (Nnwdaf_AnalyticsInfo). The consumer NF 320 may include the following parameters in the analytics information subscription (Nnwdaf_AnalyticsSubscription) or the analytics information request (Nnwdaf_AnalyticsInfo):
(1) Analytics ID=“signaling storm”;
(2) Target of Analytics Reporting: a list of NFs or one or more UE group IDs (e.g., only if reporting of a signaling storm caused by UEs is desired);
(3) Target Incident ID(s) (e.g., a signaling storm caused by UEs, a signaling storm caused by an NF, or both);
(4) Analytics Filter Information:
   i) NF ID list: instance IDs or NF set IDs of target NF that signaling storm analytics is to be provided for;
   ii) Area of Interest (AOI) and/or S-NSSAI which restricts the scope of signaling storm analytic to a specific area and/or slice;
(5) Expected Report Time: indicates the time limit by which analytics results need to be received (e.g., 10 seconds, 5 minutes, etc.);
(6) Analytics target period indicates the time period over which the statistics or predictions are requested;
(7) Optionally, preferred level of accuracy of the analytics;
(8) Analytics Reporting Information:
   i) Reporting threshold and filter:
      Signaling frequency threshold: indicates the frequency of the received signaling within the time period.
   ii) UE number threshold: indicates a threshold of the number of UEs of which the number of one type of request messages meets the frequency of UE requests threshold. For example, if the number of UEs that initiate registration requests exceeds the threshold (e.g., 10 times per hour) and the number of such UEs (i.e., the number of UEs that initiate registration requests) exceeds “100” (e.g., the threshold is preset to “100”), the NWDAF may provide the analytics.

The NWDAF 310 may collect data for signaling storm analytics from a 5GC NF 330. The 5GC NF 330 may include one or more of the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1.

For example, the NWDAF 310 may collect one or more of UE-related context data (e.g., signaling feature data), NF context, NF feature data, AF data (e.g., application activation time information), OAM data, and/or MDAF data. In addition, the NWDAF may collect UE behavioral information per UE group.

The collection of UE-related context data may be as in Table 3. The UE-related context data may include information (e.g., parameters) listed in Table 3.

TABLE 3

| Information | Source | Description |
|---|---|---|
| UE ID | | Identifies a single UE |
| Signaling feature data | | NF procedures containing signaling exchange information |
| | | related to a particular UE or session from the Connection, |
| | | Registration, Mobility and Session Managements |
| | | procedures. (NOTE 1) |
| >Request type and number from | AMF | Type and number of requests for N1 or N2 interface and |
| UE/RAN (0 . . . max) | | number of requests, such as received Initial Registration |
| | | Request, Mobility and Periodic Registration Request, |
| | | Service Request, etc. |
| >>Time duration from receiving | AMF | Time duration between the request from UE/RAN and |
| request from UE/RAN to response to | | response to UE/RAN. |
| UE/RAN | | |
| >>Number of successful responses of | AMF | Number of successful responses associated to their initial |
| UE/RAN | | requests, such as Registration Response, etc. |
| >>Number of failed responses of | AMF | Number of failed responses associated to their initial |
| UE/RAN | | requests, such as Registration Reject, Service Reject, etc. |
| >>Reason of failed responses of | AMF | Reasons of failed responses associated to their initial |
| UE/RAN | | requests, e.g. reject, no-response, etc. |
| >>A posterior Type of requests of | AMF | A posterior Request types triggered from UE/RAN, for NF |
| UE/RAN (0 . . . max) | | Service request, or request to UE/RAN. |
| >Request type and number from NF | NF, SCP | Request type received from NF, e.g. Namf_N1N2Trans, |
| (0 . . . max) | | Namf_comm, etc., as well as the number of requests |
| | | received from NF, e.g. Namf_N1N2Trans, Namf_comm, etc. |
| >>Time duration from receiving | NF, SCP | Time duration between the request from NF and response |
| request from NF to response to NF | | to NF. |
| >>Number of successful responses of | NF, SCP | Number of successful responses associated to their initial |
| NF | | requests. |
| >>Number of failed responses of NF | NF, SCP | Number of failed responses associated to their initial |
| | | requests. |
| >>Reason of failed responses of NF | NF, SCP | Reasons of failed responses associated to their initial |
| | | requests, e.g. reject, no-response, etc. |
| >>Number of redundant signaling of | NF, SCP | Number of received redundant signaling. The redundant |
| NF | | signaling means the signaling which is transmitted in |
| | | multiple times. |
| >>A posterior Type of requests of NF | NF, SCP | A posterior Request types triggered from NF, for NF |
| (0 . . . max) | | Service request. |
| >Public Warning information | AMF | Public Warning information as defined in the TS |
| | | 23.041[X], such as WRITE-REPLACE WARNING |
| | | REQUEST, etc. |
| >Frequent Mobility Registration | AMF | The number of Mobility Registration Updates N within a |
| Update | | period M may be an indication for abnormal ping-pong |
| | | behavior, where N and M are operator's configurable |
| | | parameters. |
| >Number of receiving Session Report | SMF | Number of receive Session Report from UPF triggered by |
| from UPFs | | DL packet in case of PDU Session is in 5GCM-idle state. |
| UE Context in NF | | |
| >state transition information(State | AMF, | UE related state transition information such as transition |
| transition information) | SMF | type, frequency of CM state changes etc. |
| | | State transition identifier): |
| | | “Access Type change to 3GPP access”; |
| | | “Access Type change to non-3GPP access”; |
| | | “RM state change to RM-DEREGISTERED”; |
| | | “RM state change to RM-REGISTERED”; |
| | | “CM state change to CM-IDLE”; |
| | | “CM state change to CM-CONNECTED”; |
| | | “Handover”; or |
| | | “Mobility Registration Update”. |
| | | “Frequent Mobility Registration Update”(table |
| | | 6.7.2.2-1) |
| | | Or, PDU Session related state transition information such |
| | | as transition type, frequency SM state changes, etc. |
| | | State transition identifier: |
| | | “PDU Session Establishment”; |
| | | “PDU Session Release”; |
| | | “Communication failure”; or |
| | | “PLMN change”. |
| | | It can be reported for a group of UEs (e.g., the number of |
| | | total transitions or percentage of the group UEs who have |
| | | transitions). |
| >timer information | AMF, | Timer information which has been set for the UE (e.g., |
| | SMF | timer type, duration.) |

(NOTE 1):
NWDAF can optionally provide transaction dispersion analytic information for MM and SM transactions.

The collection of NF context data may be as in Table 4. The NF context data may include information (e.g., parameters) listed in Table 4.

TABLE 4

| Information | Source | Description |
|---|---|---|
| NF ID | | NF instance ID |
| >NF profile | NRF | NF Profile information such as allowed NF information |
| | | for the NF and NF Service(s). |
| >NF load status information | NRF, | Load information indicates the current load of the NF and |
| | OAM | NF Service(s), e.g. CPU, memory, and/or percentage of |
| | | load information. |
| >Capacity and priority information | NRF, | Capacity and priority information of the registered NF |
| of NFs and NF Services | OAM, | and NF Service(s). |
| | SCP | |
| >NF heart-beat related information | NF | NF heart-beat related information such as responding |
| | | time, Number of retransmissions, heart-beat intervals. |

The collection of NF feature data may be as in Table 5. The NF feature data may include information (e.g., parameters) listed in Table 5.

TABLE 5

| Information | Source | Description |
|---|---|---|
| NF ID | | NF instance ID |
| >Usage information of UE | SMF | Usage information of UE IP address resources (dynamic |
| IP address resources | | and static, V4, V6, etc.) for CP or UP allocation, such as |
| | | number, usage, number of UE IPs, which prohibit |
| | | allocation during certain time interval, etc. This |
| | | parameter is valid for SMF only. |
| >Load information of | SMF | Load information of connected UPFs such as using PFCP |
| connected UPFs | | Load Control Information. This parameter is valid for |
| | | SMF only. |
| SCP Signaling statistics | SCP | The number of different types of signaling received and |
| | | sent by SCP during a target time period, etc. This |
| | | parameter is valid for SCP only. |

The collection of AF data may be as in Table 6. The AF data may be application activation time information, and includes information (e.g., parameters) listed in Table 6.

TABLE 6

| Information | Source | Description |
|---|---|---|
| Application ID | AF | Identifies the application providing this information. |
| User activation time | AF | Information of activation time for the users (e.g. IoT |
| information (1 . . . max) | | users) per application. |
| >Number of UEs | AF | The total number of UEs |
| >Active Time | AF | The time stamp of the users per application switch to |
| | | active, or the start and end time of the users activity per |
| | | application. |
| >Inactive Time | AF | The time stamp of the users per application switch to |
| | | inactive, or the start and end time of the users inactivity |
| | | per application, if applicable. |
| >UE type ID | AF | Identifies a group of UEs, e.g. external group ID, or a list |
| | | of UE IDs. |

The collection of OAM data may be as in Table 7. The NWDAF may collect data from an OAM (e.g., the OAM 190 of FIG. 1). The OAM data may include information (e.g., parameters) listed in Table 7.

TABLE 7

| Information | Source | Description |
|---|---|---|
| NRF ID | | NRF instance ID |
| Number of NF service registration | OAM | Number of registration request received at the NRF |
| requests | | |
| >Number of successful NF service | OAM | Number of successful registrations |
| registrations | | |
| >Number of failed NF service | OAM | Number of failed registrations |
| registrations due to encoding error of | | |
| NF profile | | |
| >Number of failed NF service | OAM | Number of failed registrations |
| registrations due to NRF internal error | | |
| >Received time | OAM | Time stamp that the related request is received at the NRF. |
| Number of NF service update requests | OAM | Number of update request received at the NRF |
| >Number of successful NF service | OAM | Number of successful updates |
| updates | | |
| >Number of failed NF service updates | OAM | Number of failed updates |
| due to encoding error of NF profile | | |
| >Number of failed NF service updates | OAM | Number of failed updates |
| due to NRF internal error | | |
| >Received time | OAM | Time stamp that the related request is received at the NRF. |
| Number of NF discovery requests | OAM | Number of discovery request received at the NRF |
| >Number of successful NF | OAM | Number of successful discovery attempts |
| discoveries | | |
| >Number of failed NF service | OAM | Number of failed discovery attempts |
| discoveries due to unauthorized NF | | |
| Service consumer | | |
| >Number of failed NF discoveries | OAM | Number of failed discovery attempts |
| due to input errors | | |
| >Number of failed NF discoveries | OAM | Number of failed discovery attempts |
| due to NRF internal error | | |
| >Received time | OAM | Time stamp that the related request is received at the NRF. |

The collection of MDAF data may be as in Table 8. The NWDAF may collect data from an MDAF (e.g., the MDAF 177 of FIG. 1) (e.g., MDAS/MDAF) of control plane congestion analytics. The MDAF data may include information (e.g., parameters) listed in Table 8.

TABLE 8

| Information | Source | Description |
|---|---|---|
| affectedObject | MDAF | Indication of 5GC NFs where |
| | | congestion issues occurred |
| | | or potentially may occur. |
| cPCongestionIssueID | MDAF | This field holds the ID of |
| | | the control plane congestion |
| | | issue which is reported. |

The NWDAF 310 may generate analytics information about the signaling storm based on the collected data, and provide the analytics information (e.g., signaling storm statistics and/or signaling storm predictions) to the consumer NF 320.

An example of output of the analytics information from the NWDAF 310 may be signaling storm statistics. The signaling storm statistics may be as in Table 9.

TABLE 9

| Information | Description |
|---|---|
| Report (1 . . . max) | List of observed signaling storm statistics. |
| >Target NF ID | A list of impacted NFs of signaling storm detected by NWDAF. |
| >Cause of the signaling storm | The potential cause of NF Abnormality (i.e. massive signaling from |
| | UE or NF abnormal signaling). |
| >Source UE/NF | Group of the UE(s) identified as slice ID or internal group ID or NF(s) |
| | identified as NF list which cause the signaling storm. |
| >(OPTIONAL) signaling information | The statistics of signaling information. |
| >>Received Signaling Analytics | Information of signaling received by the target NF(s). |
| >>>Total number of received | Indicates the statistics on the number of signaling messages received |
| signaling | by the target NF(s) in the time slot. |
| >>>Growth rate of received | Difference between the number of signaling messages received by the |
| signaling | NF in the time slot and the number of signaling messages received by |
| | the target NF(s) in the previous time slot. |
| >>>Signaling analytics of | Indicates the statistics on the number of signaling messages received |
| UF | from UEs within the time slot. NOTE 1 |
| >(OPTIONAL) Timer List | The list of timer information per source UE(s). NOTE 1 |
| >>Type of timer | The type of timer which has been set. |
| >>Timer duration | The timer duration that has be selected for the source UE(s). |

NOTE 1:
Only available when Cause of signaling storm is massive signaling from UEs, and there exists Source UE(s).

Another example of output of the analytics information from the NWDAF 310 may be signaling storm predictions. The signaling storm predictions may be as in Table 10.

TABLE 10

| Information | Description |
|---|---|
| (Report (1 . . . max) | List of predicted signaling storm analytics. |
| >Target NF ID | A list of impacted NFs signaling storm predicted by NWDAF. |
| >Cause of the signaling storm | The potential cause of NF Abnormality (i.e. massive signaling from |
| | UE or NF abnormal signaling). |
| >Source UE/NF | Group of the UE(s) identified as slice ID or internal group ID or NF(s) |
| | identified as NF list which cause the signaling storm. |
| >(OPTIONAL) signaling information | The predicted of signaling information. |
| >>Reference Point | The information of the reference point impacted. |
| >>Service Operation(s) | The information of the service operation(s) impacted. |
| >>Received Signaling Analytics | Information of signaling received by the target NF(s). |
| >>>Received number of | Received number of signaling of the specific signaling type. |
| signaling | |
| >>>Growth rate of received | Difference between the number of signaling messages received by the |
| signaling | NF in the time slot and the number of signaling messages received by |
| | the target NF(s) in the previous time slot. |
| >>>Signaling analytics of UE | Indicates the statistics on the number of signaling messages received |
| | from UEs within the time slot. NOTE 1 |
| >(OPTIONAL) Timer List | The list of timer information per Source UE(s). NOTE 1 |
| >>Type of timer | The type of timer. |
| >>Timer duration | The timer duration that commonly is selected for the Source UE(s). |
| >Priority | Priority (relative to other NFs of the same type) of candidate NFs as |
| | defined in the TS 29.510 [18]. |
| >Capacity | Candidate NF capacity information, expressed as a weight relative to |
| | other NF instances of the same type as defined in the TS 29.510 [18]. |
| >Confidence | Confidence of this prediction. |

NOTE 1:
Only available when Cause of signaling storm is massive signaling from UEs, and there exists Source UE(s).

Still another example of output of the analytics information from the NWDAF 310 may include the signaling storm statistics and the signaling storm predictions described above.

The consumer NF 320 may perform an action (e.g., an operation for mitigation and/or prevention) based on the analytics information (e.g., the signaling storm statistics and/or the signaling storm predictions). The operation for mitigation and/or prevention may be based on the policy/configuration of an operator and NF implementation. Table 11 shows examples of causes of the signaling storm and corresponding actions.

TABLE 11

| Cause of the signaling storm | Actions of NFs |
|---|---|
| Massive signaling from UE | AMF sets MM NAS related timer (e.g. back-off, T3512) with |
| | suggested time range for a selected set of UEs. |
| Massive signaling from UE | SMF sets SM NAS related timer (e.g. back-off) with suggested time |
| | range for a selected set of Sessions. |
| Massive signaling from UE | AMF/SMF sets suggested N1/N2 interface related ingress/egress |
| | threshold, or AMF triggers RAN to initiate overload control for a |
| | selected set of UEs in specific slice or priority as defined in clause |
| | 8.7.7 of TS 38.413 [8] to start overload control.) The AMF may |
| | assign an abnormal slice to the UEs and initiate overload control for |
| | the specific slice. |
| NF abnormal signaling | NRF configures the local policy to prevent the source NF with |
| | abnormal signaling from being discovered or discovering others. |
| NF abnormal signaling | Source NF configures to (re)select other NFs instead of NF with |
| | abnormal signaling and may unsubscribes the NF with abnormal |
| | signaling. |
| NF abnormal signaling | Source NF configures to deprioritize the NFs/Services with abnormal |
| | signaling from being selected. |
| NF abnormal signaling | Source NF triggers UE Reregistration and/or Session |
| | Reestablishments to avoid NF with abnormal signaling. |
| NF abnormal signaling | SCP blocks or throttles messages originating from an NF/service with |
| | abnormal signaling. |
| NF abnormal signaling | SCP redirects requests towards an NF service producer with abnormal |
| | signaling towards another service producer. |
| NF abnormal signaling | SCP notifies communication peers of an NF with abnormal signaling |
| | about abnormal condition, e.g. high load. |

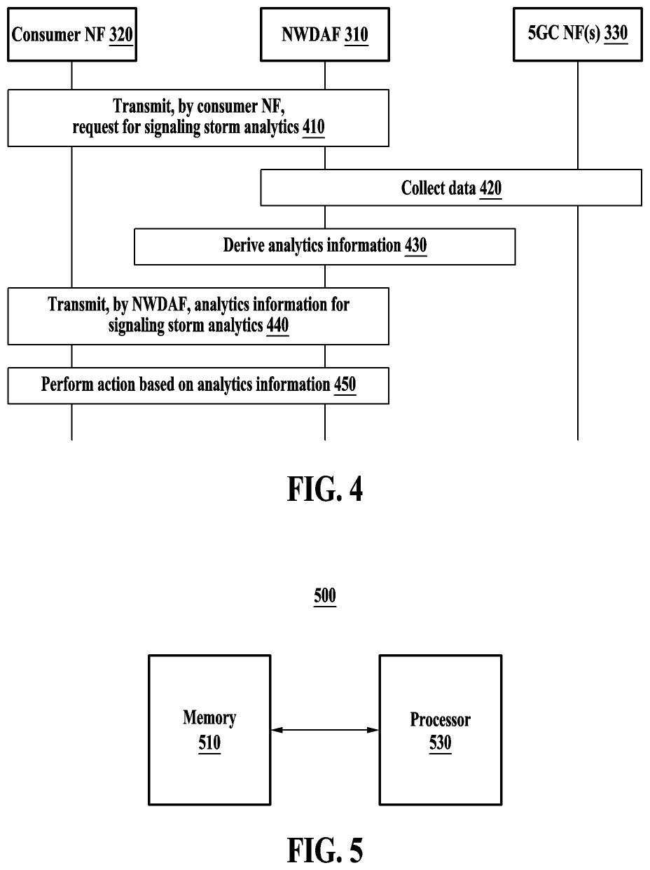

FIG. 4 is a flowchart illustrating a method of controlling a network signaling storm according to an embodiment.

FIG. 4 shows the procedure for supporting mitigation and/or prevention of a network signaling storm. The NWDAF 310 may provide analytics information about a signaling storm, thereby supporting mitigation and/or prevention of a signaling storm.

In operation 410, the consumer NF 320 (e.g., an MDAF/MDAS) may transmit a request for signaling storm analytics to the NWDAF 310. The request for signaling storm analytics may include analytics information subscription (Nnwdaf_AnalyticsSubscription) or analytics information request (Nnwdaf_AnalyticsInfo). For example, the consumer NF 320 may subscribe to or transmit a request to analytics information for signaling storm analytics (e.g., statistics and/or predictions for a signaling storm) using an Nnwdaf_AnalyticsSubscription_Subscribe or Nnwdaf_AnalyticsInfo_Request service operation. The analytics information may be NWDAF assistance information.

The request for signaling storm analytics may include thresholds such as a confidence level and/or accuracy of detection. In addition, the request for signaling storm analytics may include, as analytic filters, an indication of the use case for a signaling storm (e.g. a signaling storm due to UE mobility).

Analytics ID may be set to “signaling storm analytics”. The target for analytics reporting may be set to be any NF or any UE. The analytic filters may be provided as described with reference to FIG. 3.

The consumer NF 320 may request a combination of one or more of statistics, predictions, mitigation, and prevention for a given analytics target period.

The consumer NF 320 may subscribe to “NF load analytics” from the NWDAF 310, and trigger the signaling storm analytics based on output (or analytics information) of the NF load analytics (e.g., CPU usage of 80% or more). In addition, the consumer NF 320 may subscribe to “abnormal behavior” analytics from the NWDAF 310, and trigger the signaling storm analytics based on output of the abnormal behavior analytics (e.g., suspicion of DDoS attack). Further, the consumer NF 320 may subscribe to “dispersion (or dispersion analytics)” analytics from the NWDAF 310, and trigger the signaling storm analytics according to the results of the dispersion analytics (e.g., when the transaction dispersion exceeds an expected transaction dispersion configurable threshold).

In operation 420, the NWDAF 310 may collect data (or input data) for signaling storm analytics from the 5GC NF 330. For example, to collect data for signaling storm analytics, the NWDAF 310 may retrieve the data from the 5GC NF 330 using Nnf_EventExposure_Subscribe.

The data may include one or more of UE-related context data (e.g., signaling feature data), NF context, NF feature data, AF data (e.g., application activation time information), OAM data, MDAF data, and/or UE behavioral information (e.g., UE behavioral information per UE group).

The NWDAF may optionally request additional data aligned with an analysis target identified in operation 410.

In operation 430, the NWDAF 310 may derive analytics information for signaling storm analytics based on the request (e.g., the request for signaling storm analytics) from the consumer NF 320 and the collected data. The NWDAF 310 may collect additional data from other NFs including MDAF/MDAS/NWDAF. If the use case of a signaling storm is provided in response to the request for signaling storm analytics in operation 410, the NWDAF 310 may collect the data from the 5GC NF 330 based on the use case of a signaling storm.

In operation 440, the NWDAF may invoke Nnwdaf_AnalyticsSubscription_Notify or Nnwdaf_AnalyticsInfo_Request response or a response to the consumer NF for the output data analytics. The NWDAF 310 may transmit the analytics information for signaling storm analytics to the consumer NF 320. To output the analytics information, the NWDAF 310 may invoke the Nnwdaf_AnalyticsSubscription_Notify or Nnwdaf_AnalyticsInfo_Request response or the response to the consumer NF 320.

In operation 450, the consumer NF 320 may perform an action based on the analytics information. Upon receiving the detection and/or prediction and/or mitigation, the consumer NF 320 may perform an action according to the description of Table 11.

FIG. 5 is a schematic block diagram of a device for performing an NWDAF according to an embodiment.

Referring to FIG. 5, according to an embodiment, a device 500 for performing an NWDAF (e.g., a server device) may be substantially the same as the NWDAF (e.g., the NWDAF 180 of FIG. 1, the NWDAF 210 of FIG. 2, or the NWDAF 310 of FIG. 3) described with reference to FIGS. 1 to 4. The device 500 may include a memory 510, and a processor 530.

The memory 510 may store instructions (e.g., a program) executable by the processor 530. For example, the instructions may include instructions for executing the operation of the processor 530 and/or the operation of each component of the processor 530.

The memory 510 may be implemented as a volatile memory device or a non-volatile memory device. The volatile memory device may be implemented as a dynamic random-access memory (DRAM), a static random-access memory (SRAM), a thyristor RAM (T-RAM), a zero capacitor RAM (Z-RAM), or a twin transistor RAM (TTRAM). The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), and/or an insulator resistance change memory.

The processor 530 may execute computer-readable code (e.g., software) stored in the memory 510 and instructions triggered by the processor 530. The processor 530 may be a hardware-implemented data processing device having a circuit that is physically structured to execute desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The operation performed by the processor 530 may be substantially the same as the operation of the NWDAF (e.g., the NWDAF 180 of FIG. 1, the NWDAF 210 of FIG. 2, or the NWDAF 310 of FIG. 3) described with reference to FIGS. 1 to 4. Accordingly, a further description thereof will be omitted.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of controlling a signaling storm, the method comprising:
receiving a request for analytics of a signaling storm from a consumer network function (NF);
collecting data for the analytics of the signaling storm from a fifth-generation core (5GC) NF;
generating analytics information about the signaling storm based on the collected data; and
transmitting the analytics information to the consumer NF,
wherein the analytics information comprises one of statistics and predictions regarding control of the signaling storm to mitigate or prevent a network abnormal behavior.

2. The method of claim 1, wherein the analytics information is regarding an expected normal level of the signaling storm and deviations indicating the signaling storm.

3. The method of claim 2, wherein the generating comprises identifying whether the signaling storm is due to signaling from a predetermined NF or signaling from a user equipment (UE) based on analytics identification (ID) of the signaling storm included in the request.

4. The method of claim 1, wherein
the data comprises UE-related context data, and
the UE-related context data comprises information regarding:
a time duration from receiving a request from a UE to response to the UE;
a number of successful responses of the UE;
a number of failed responses of the UE;
a frequent mobility registration update;
a UE context in an NF;
state transition information; and
timer information.

5. The method of claim 4, wherein the timer information is timer information set for the UE, and comprises a timer type and a duration.

6. The method of claim 1, wherein
the data comprises application function (AF) data indicating application activation time information, and
the AF data comprises information regarding:
an application ID;
user activation time information;
a number of UEs;
an active time;
an inactive time; and
a UE type ID.

7. The method of claim 1, wherein an action for the signaling storm is performed based on the analytics information.

8. The method of claim 7, wherein, if the consumer NF is an access and mobility management function (AMF), the action is setting a mobility management non-access stratum (MM NAS)-related timer.

9. The method of claim 7, wherein, if the consumer NF is a session management function (SMF), the action is setting a session management non-access stratum (SM NAS)-related timer.

10. A server device for controlling a signaling storm, the server device comprising:
a processor; and
a memory electrically connected to the processor and configured to store instructions executable by the processor,
wherein the instructions, when executed by the processor, cause the server device to perform a plurality of operations, the plurality of operations comprising:
receiving a request for analytics of a signaling storm from a consumer network function (NF);
collecting data for the analytics of the signaling storm from a fifth-generation core (5GC) NF;
generating analytics information about the signaling storm based on the collected data; and
transmitting the analytics information to the consumer NF,
wherein the analytics information comprises one of statistics and predictions regarding control of the signaling storm to mitigate or prevent a network abnormal behavior.

11. The server device of claim 10, wherein the analytics information is regarding an expected normal level of the signaling storm and deviations indicating the signaling storm.

12. The server device of claim 11, wherein the generating comprises identifying whether the signaling storm is due to signaling from a predetermined NF or signaling from a user equipment (UE) based on analytics identification (ID) of the signaling storm included in the request.

13. The server device of claim 10, wherein
the data comprises UE-related context data, and
the UE-related context data comprises information regarding:
a time duration from receiving a request from a UE to response to the UE;
a number of successful responses of the UE;
a number of failed responses of the UE;
a frequent mobility registration update;
a UE context in an NF;
state transition information; and
timer information.

14. The server device of claim 13, wherein the timer information is timer information set for the UE, and comprises a timer type and a duration.

15. The server device of claim 10, wherein
the data comprises application function (AF) data indicating application activation time information, and
the AF data comprises information regarding:
an application ID;
user activation time information;
a number of UEs;
an active time;
an inactive time; and
a UE type ID.

16. The server device of claim 10, wherein an action for the signaling storm is performed based on the analytics information.

17. The server device of claim 16, wherein, if the consumer NF is an access and mobility management function (AMF), the action is setting a mobility management non-access stratum (MM NAS)-related timer.

18. The server device of claim 16, wherein, if the consumer NF is a session management function (SMF), the action is setting a session management non-access stratum (SM NAS)-related timer.
